(19) United States
(12) Patent Application Publication
(10) Pub. No.: US 2022/0318572 A1
(43) Pub. Date: Oct. 6, 2022

(54) Inference Processing Apparatus and Inference Processing Method

(71) Applicant: Nippon Telegraph and Telephone Corporation, Tokyo (JP)

(72) Inventors: Huycu Ngo, Tokyo (JP); Yuki Arikawa, Tokyo (JP); Takeshi Sakamoto, Tokyo (JP)

(21) Appl. No.: 17/615,610

(22) PCT Filed: Jun. 5, 2019
(86) PCT No.: PCT/JP2019/022313

§ 371 Date: Dec. 1, 2021

(51) Int. Cl. G06K 9/62; G06N 3/04

(52) U.S. Cl. CPC G06K 9/6262; G06K 9/6228; G06N 3/04

(57) ABSTRACT

An inference processing apparatus infers a feature of input data X using a trained neural network and includes a storage unit that stores the input data X and a weight W of the trained neural network, a setting unit that sets a bit accuracy of inference calculation and a number of units of the trained neural network based on an input inference accuracy, and an inference calculation unit that performs an inference calculation of the trained neural network, taking the input data X and the weight W as inputs, based on the bit accuracy of the inference calculation and the number of units set by the setting unit to infer the feature of the input data X.

### CROSS-REFERENCE TO RELATED APPLICATIONS

This application is a national phase entry of PCT Application No. PCT/JP2019/022313, filed on Jun. 5, 2019, which application is hereby incorporated herein by reference.

### TECHNICAL FIELD

The present invention relates to an inference processing apparatus and an inference processing method, and more particularly to a technique for performing inference using a neural network.

### BACKGROUND

In recent years, the amount of data generated has increased explosively with an increasing number of edge devices such as mobile terminals and Internet of Things (IoT) devices. A state-of-the-art machine learning technology called a deep neural network (DNN) is superior in extracting meaningful information from such an enormous amount of data. Due to recent advances in research on DNNs, the accuracy of data analysis has been significantly improved and further development of technology using DNNs is expected.

The processing of a DNN has two phases, training and inference. In general, training requires a large amount of data and is sometimes processed in a cloud. On the other hand, inference uses a trained DNN model to estimate an output for unknown input data.

More specifically, in DNN-based inference processing, input data such as time series data or image data is given to a trained neural network model to infer features of the input data. For example, according to a specific example disclosed in Non Patent Literature 1, a sensor terminal equipped with an acceleration sensor and a gyro sensor is used to detect events such as rotation or stopping of a garbage truck to estimate the amount of waste. In this way, a pre-trained neural network model trained using time series data in which events at times are known is used to estimate an event at each time by taking unknown time series data as an input.

In Non Patent Literature 1, it is necessary to extract events in real time using time series data acquired from the sensor terminal as input data. Therefore, it is necessary to speed up the inference processing. Thus, in a technique of the related art, an FPGA that implements inference processing is mounted on a sensor terminal and inference calculation is performed with the FPGA to speed up the processing (see Non Patent Literature 2).

When the inference processing is speeded up using the technique of the related art, the processing time can be shortened by reducing the bit accuracy. A faster processing time can also be achieved by reducing the number of units (also referred to as the number of nodes), which is the size of a neural network such as a DNN, and reducing the amount of calculation.

### CITATION LIST

### Non Patent Literature

Non Patent Literature 1: Kishino, et. al, “Detecting Garbage Collection Duration Using Motion Sensors Mounted on a Garbage Truck Toward Smart Waste Management,” SPWID17

Non Patent Literature 2: Kishino, et. al, “Datafying City: Detecting and Accumulating Spatio-temporal Events by Vehicle-mounted Sensors,” BIGDATA 2017.

### SUMMARY

### Technical Problem

However, in the technique of the related art, if the bit accuracy is reduced when inference processing is performed, the processing time can be reduced, but the inference accuracy may deteriorate. In this case, if an adjustment is made to increase the number of units of the neural network, the inference accuracy is improved, but the latency which is a delay time of the inference processing increases. Thus, it is difficult to reduce the processing time of inference calculation while maintaining a certain inference accuracy.

Embodiments of the present invention have been made to solve the above problems and it is an object of embodiments of the present invention to provide an inference processing technique capable of reducing the processing time of inference calculation while maintaining a certain inference accuracy.

### Means for Solving the Problem

An inference processing apparatus according to embodiments of the present invention to solve the above problems is an inference processing apparatus that infers a feature of input data using a trained neural network, the inference processing apparatus including a first storage unit configured to store the input data, a second storage unit configured to store a weight of the trained neural network, a setting unit configured to set a bit accuracy of inference calculation and a number of units of the trained neural network based on an input inference accuracy, and an inference calculation unit configured to perform an inference calculation of the trained neural network, taking the input data and the weight as inputs, based on the bit accuracy of the inference calculation and the number of units set by the setting unit to infer the feature of the input data.

In the inference processing apparatus according to embodiments of the present invention, the setting unit may include a selection unit configured to select a plurality of combinations of the bit accuracy of the inference calculation and the number of units, a first estimation unit configured to estimate an inference accuracy of the feature of the input data inferred by the inference calculation unit based on each of the plurality of selected combinations, a second estimation unit configured to estimate a latency which is a delay time of inference processing including the inference calculation performed by the inference calculation unit based on each of the plurality of selected combinations, a first determination unit configured to determine whether or not the inference accuracy estimated by the first estimation unit satisfies the input inference accuracy, a second determination unit configured to determine whether or not the latency estimated by the second estimation unit is a minimum among latencies estimated for the plurality of combinations, and an output unit configured to output a bit accuracy of inference calculation and a number of units of a combination with which the first determination unit has determined that the input inference accuracy is satisfied and the second determination unit has determined that the estimated latency is the minimum.

In the inference processing apparatus according to embodiments of the present invention, the setting unit may further include a third estimation unit configured to estimate an amount of hardware resources used for inference calculation of the inference calculation unit corresponding to each of the plurality of selected combinations, and a third determination unit configured to determine whether or not the amount of hardware resources estimated by the third estimation unit satisfies a criterion set for the amount of hardware resources, and the output unit is configured to output a bit accuracy of inference calculation and a number of units of a combination with which the third determination unit has further determined that the criterion set for the amount of hardware resources is satisfied.

In the inference processing apparatus according to embodiments of the present invention, the setting unit may further include a fourth estimation unit configured to estimate a power consumption of the inference calculation unit, which performs an inference calculation of the trained neural network to infer the feature of the input data, based on each of the plurality of selected combinations, and a fourth determination unit configured to determine whether or not the power consumption estimated by the fourth estimation unit satisfies a criterion set for the power consumption, and the output unit is configured to output a bit accuracy of inference calculation and a number of units of a combination with which the fourth determination unit has further determined that the criterion set for the power consumption is satisfied.

In the inference processing apparatus according to embodiments of the present invention, the selection unit may be configured to select a plurality of combinations of a bit accuracy of the input data, a bit accuracy of weight data, the bit accuracy of the inference calculation, and the number of units.

The inference processing apparatus according to embodiments of the present invention may further include an acquisition unit configured to acquire an inference accuracy of the feature of the input data inferred by the inference calculation unit, and a fifth determination unit configured to determine whether or not the inference accuracy acquired by the acquisition unit is lower than a set inference accuracy, wherein the setting unit is configured to set at least one of the bit accuracy of the inference calculation and the number of units based on the input inference accuracy when the fifth determination unit has determined that the inference accuracy acquired by the acquisition unit is lower than the set inference accuracy.

An inference processing method according to embodiments of the present invention to solve the above problems is an inference processing method performed by an inference processing apparatus for inferring a feature of input data using a trained neural network, the inference processing method including a first step of setting a bit accuracy of inference calculation and a number of units of the trained neural network based on an input inference accuracy, and a second step of performing an inference calculation of the trained neural network, taking the input data stored in a first storage unit and a weight of the trained neural network stored in a second storage unit as inputs, based on the bit accuracy of the inference calculation and the number of units set in the first step to infer the feature of the input data.

In the inference processing method according to embodiments of the present invention, the second step may include a third step of selecting a plurality of combinations of the bit accuracy of the inference calculation and the number of units, a fourth step of estimating an inference accuracy of the feature of the input data inferred in the second step based on each of the plurality of selected combinations, a fifth step of estimating a latency which is a delay time of inference processing including the inference calculation performed in the second step based on each of the plurality of selected combinations, a sixth step of determining whether or not the inference accuracy estimated in the fourth step satisfies the input inference accuracy, a seventh step of determining whether or not the latency estimated in the fourth step is a minimum among latencies estimated for the plurality of combinations, and an eighth step of outputting a bit accuracy of inference calculation and a number of units of a combination with which it has been determined in the sixth step that the input inference accuracy is satisfied and it has been determined in the seventh step that the estimated latency is the minimum.

### Effects of Embodiments of the Invention

According to embodiments of the present invention, it is possible to reduce the processing time of inference calculation while maintaining a certain inference accuracy because the bit accuracy of inference calculation and the number of units of the trained neural network are set based on the input inference accuracy.

### BRIEF DESCRIPTION OF THE DRAWINGS

FIG. 1 is a block diagram illustrating a configuration of an inference processing apparatus according to a first embodiment of the present invention.

FIG. 2 is a block diagram illustrating a configuration of a setting unit according to the first embodiment.

FIG. 3 is a block diagram illustrating a hardware configuration of the inference processing apparatus according to the first embodiment.

FIG. 4 is a diagram for explaining the setting unit according to the first embodiment.

FIG. 5 is a flowchart illustrating an operation of the inference processing apparatus according to the first embodiment.

FIG. 6 is a flowchart illustrating a setting process according to the first embodiment.

FIG. 7 is a block diagram illustrating a configuration of an inference processing apparatus according to a second embodiment.

FIG. 8 is a flowchart for explaining an operation of the inference processing apparatus according to the second embodiment.

FIG. 9 is a block diagram illustrating a configuration of a setting unit according to a third embodiment.

FIG. 10 is a diagram for explaining the setting unit according to the third embodiment.

FIG. 11 is a flowchart illustrating a setting process according to the third embodiment.

FIG. 12 is a block diagram illustrating a configuration of a setting unit according to a fourth embodiment.

FIG. 13 is a diagram for explaining the setting unit according to the fourth embodiment.

FIG. 14 is a flowchart illustrating a setting process according to the fourth embodiment.

FIG. 15 is a block diagram illustrating a configuration of an inference processing apparatus according to an example of the related art.

### DETAILED DESCRIPTION OF ILLUSTRATIVE EMBODIMENTS

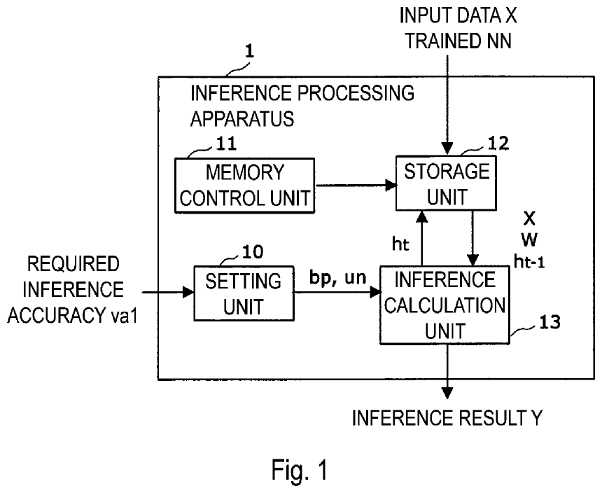

Hereinafter, preferred embodiments of the present invention will be described in detail with reference to FIGS. 1 to 15.

Outline

First, an outline of an inference processing apparatus 1 according to an embodiment of the present invention will be described. FIG. 1 is a block diagram illustrating a configuration of an inference processing apparatus 1 according to a first embodiment of the present invention. The inference processing apparatus 1 according to the present embodiment uses image data or time series data such as audio data and language data acquired from an external sensor (not illustrated) as input data X to be inferred. The inference processing apparatus 1 sets the bit accuracy of inference calculation and the number of units that is the size of a neural network, which minimize the latency of the entire inference processing, based on the required inference accuracy.

Here, “required inference accuracy” refers to an inference accuracy required by a system or service to which the inference processing apparatus 1 is applied. Examples include an inference accuracy desired by a user according to a hardware or system configuration used, the nature of the input data X, or the like.

Trained neural network models constructed in advance for different network sizes are loaded into the inference processing apparatus 1. The inference processing apparatus 1 sets the number of units of a trained neural network and a bit accuracy used for an inference calculation of the trained neural network based on the required inference accuracy.

The inference processing apparatus 1 performs an inference calculation of a neural network (NN) based on the set bit accuracy of inference calculation by using a trained neural network having the set number of units to infer features of the input data X, and outputs an inference result Y.

For example, the inference processing apparatus 1 uses a trained NN model that has been pre-trained using input data X such as time series data in which events at times are known. The inference processing apparatus 1 estimates an event at each time by using input data X such as unknown time series data and weight data W of a trained NN as inputs. The input data X and the weight data W are matrix data.

For example, the inference processing apparatus 1 can estimate the amount of waste by detecting events such as rotation or stopping of a garbage truck using input data X acquired from sensors including an acceleration sensor and a gyro sensor (see Non Patent Literature 1).

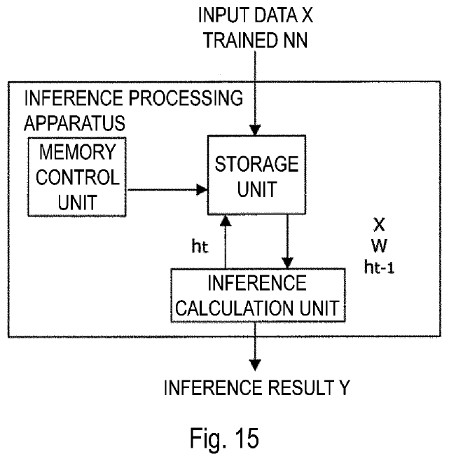

On the other hand, the inference processing apparatus of the related art illustrated in FIG. 15 takes input data X and weight data W of a trained NN having a predetermined network size as inputs and performs an inference calculation based on a predetermined bit accuracy of the inference calculation, and outputs an inference result Y. In the inference processing apparatus of the related art, if a change is made to decrease only the bit accuracy of calculation, the inference accuracy may decrease. In this case, if a change is also made to increase the number of units of the NN model and a calculation using the trained NN with the increased number of units is performed, the latency of the entire inference processing may increase.

The size of the neural network, the inference accuracy, and the latency (also called a delay time), which is a response time of the inference processing, are considered to be closely related to each other. The inference processing apparatus 1 according to the present embodiment has a feature that a network size of the NN model and a bit accuracy of inference calculation which reduce the latency of the entire inference processing are preset based on the required inference accuracy.

The following description will refer to the case where a recurrent neural network (RNN) is used as an NN model as an example.

Configuration of Inference Processing Apparatus

As illustrated in FIG. 1, the inference processing apparatus 1 includes a setting unit 10, a memory control unit 11, a storage unit (a first storage unit and a second storage unit) 12, and an inference calculation unit 13.

Functional Blocks of Setting Unit

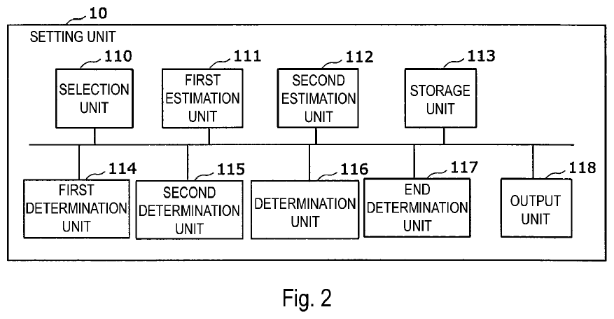

As illustrated in FIG. 2, the setting unit 10 includes a selection unit 110, a first estimation unit 111, a second estimation unit 112, a storage unit 113, a first determination unit 114, a second determination unit 115, a determination unit 116, an end determination unit 117, and an output unit 118.

As illustrated in FIG. 1, the setting unit 10 sets a bit accuracy (bp) corresponding to the calculation precision of the inference calculation unit 13 and the number of units (un) corresponding to the size of an NN model to be used based on a required inference accuracy (va1) which is information input from the outside.

The bit accuracy of inference calculation includes double precision, single precision, half precision, and the like. Further, units corresponding to neurons of an NN model each perform a neural network calculation including calculation of a sum of products of input values and weights and determination of an output using an activation function.

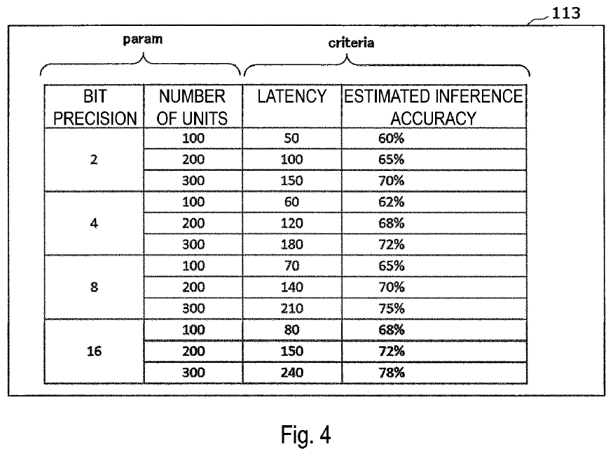

Here, first, the relationship between the bit accuracy of inference calculation, the number of units of the NN model, a latency of the inference processing, and the inference accuracy will be described with reference to FIG. 4.

As shown in FIG. 4, the inference accuracy and the latency of the entire inference processing differ depending on the bit accuracy of inference calculation and the number of units of the NN model. For example, when the bit accuracy of inference calculation is “2 bits” and the number of units of the NN model is “100,” the latency of the inference processing in the NN model is “50 μs,” but the inference accuracy is “60%.” When the same bit accuracy “2 bits” is used and the number of units is “300,” the latency becomes as large as “150 μs,” but the inference accuracy is also improved to “70%.”

When the bit accuracy is “16 bits” and the number of units is “100,” the latency of the inference processing is “80 μs,” but the inference accuracy obtained is “68%.” When the bit accuracy of inference calculation is increased while the number of units of the NN model is the same, the inference accuracy is improved, but the latency is also increased as described above. Also, when the number of units of the NN model is increased while the bit accuracy of inference calculation is the same, the inference accuracy is improved, but the latency is increased.

Based on such a relationship, the setting unit 10 sets a bit accuracy of inference calculation and the number of units of the NN model which achieve the required inference accuracy and minimize the latency of the entire inference processing.

Hereinafter, each functional block of the setting unit 10 will be described with reference to FIG. 2.

The selection unit 110 selects combinations of the bit accuracy of inference calculation and the number of units of the NN model. More specifically, the selection unit 110 selects an arbitrary bit accuracy from a preset range of values of bit accuracy, for example, a range of 2 bits to 16 bits. The selection unit 110 also selects an arbitrary number of units from a preset range of the numbers of units of the NN model, for example, a range of 100 to 300.

The selection unit 110 may apply an arbitrary algorithm to generate a combination of the bit accuracy and the number of units. The selection unit 110 can also arbitrarily select a more detailed data type such as a fixed point or a floating point when selecting the bit accuracy.

In the example of FIG. 4, the selection unit 110 selects four different values of the bit accuracy, 2 bits, 4 bits, 8 bits, and 16 bits, and three different numbers of units, 100, 200, and 300, as shown in the first and second columns from the left and selects all possible combinations thereof.

The first estimation unit 111 estimates inference accuracies for the candidate combinations of the bit accuracy and the number of units selected by the selection unit 110. More specifically, the first estimation unit 111 estimates the inference accuracies of the features of input data X inferred by the inference calculation unit 13 based on the selected combinations of the bit accuracy and the number of units.

For example, the first estimation unit 111 obtains the inference accuracy by performing inference calculation for each combination of the bit accuracy and the number of units selected by the selection unit 110 using a trained NN which has been constructed through pre-training using an external calculation device (not illustrated) or the like. The inference accuracy estimated by the first estimation unit 111 is stored in the storage unit 113 in association with the combination of the bit accuracy and the number of units as shown in FIG. 4.

The second estimation unit 112 estimates the latencies of the entire inference processing for the candidate combinations of the bit accuracy and the number of units selected by the selection unit 110. More specifically, based on each of the selected combinations, the second estimation unit 112 estimates the latency which is the delay time of the inference processing including the inference calculation performed by the inference calculation unit 13.

The second estimation unit 112 acquires, for example, the latency in units of multipliers and adders of each bit accuracy in advance, and estimates the amount of calculation for each number of units of the NN model. Thereby, the second estimation unit 112 can estimate the latency for each combination of the bit accuracy and the number of units selected by the selection unit 110. The latency calculated by the second estimation unit 112 is stored in the storage unit 113 in association with the combination of the bit accuracy and the number of units as shown in FIG. 4.

The first estimation unit 110 and the second estimation unit 112 can estimate the inference accuracies and the latencies, respectively, for example, at the time of circuit design of the inference calculation unit 13. Circuits are constructed in advance for trained NN models having a plurality of network sizes, that is, trained NN models having different numbers of units, at the time of circuit design of the inference calculation unit 13.

The storage unit 113 stores the combinations of the bit accuracy and the number of units selected by the selection unit 110. The storage unit 113 also stores the inference accuracy of each combination estimated by the first estimation unit 111. The storage unit 113 also stores the latency of the entire inference processing of each combination calculated by the second estimation unit 112. For example, as shown in FIG. 4, the storage unit 113 can hold the bit accuracy and the number of units used as parameters (“param” in FIG. 4) and the latency and the inference accuracy on the evaluation axis (“criteria” in FIG. 4) in a table format in association with each other.

The first determination unit 114 determines whether or not the inference accuracies obtained with the combinations of the bit accuracy and the number of units estimated by the first estimation unit 111 each satisfy the required inference accuracy. More specifically, the first determination unit 114 compares each inference accuracy estimated by the first estimation unit 111 with the required inference accuracy. The first determination unit 114 can determine that the estimated inference accuracy satisfies the required inference accuracy when the value of the estimated inference accuracy is larger than the value of the required inference accuracy.

For example, consider the case where the required inference accuracy is 70%. In this case, as shown in FIG. 4, the first determination unit 114 determines that four combinations, a combination of a bit accuracy “4 bits” and the number of units “300” (whose estimated inference accuracy is 72%), a combination of a bit accuracy “8 bits” and the number of units “300” (whose estimated inference accuracy is 75%), a combination of a bit accuracy “16 bits” and the number of units “200” (whose estimated inference accuracy is 72%), and a combination of a bit accuracy “16 bits” and the number of units “300” (whose estimated inference accuracy is 78%), satisfy the required inference accuracy (70%).

The second determination unit 115 determines whether or not the latency of the entire inference processing based on each combination of the bit accuracy and the number of units estimated by the second estimation unit 112 is the minimum. For example, consider the case where the required inference accuracy is 70% according to the above example. In the table stored in the storage unit 113 shown in FIG. 4, “180 μs,” “210 μs,” “150 μs,” and “240 μs” are stored as “estimated latencies” corresponding to the four combinations mentioned above. The second determination unit 115 determines that the latency of “150 μs” is the minimum of the latency values. The determination result of the second determination unit 115 is stored in the storage unit 113.

When determining that the latency is the minimum, the second determination unit 115 may also make a determination through comparison with a preset threshold latency value.

Based on the determination result of the second determination unit 115, the determination unit 116 tentatively determines that, of the combinations of the bit accuracy and the number of units that satisfy the required inference accuracy, a combination with which the minimum latency has been estimated is that of the bit accuracy and the number of units of the NN model to be used for inference calculation of the inference calculation unit 13.

The end determination unit 117 performs an end determination as to whether or not the determination as to whether the required inference accuracy is satisfied and the latency is the minimum has been made for all candidate combinations of the bit accuracy and the number of units tentatively determined by the determination unit 116. The end determination unit 117 passes a combination of the bit accuracy and the number of units, which has been tentatively determined at least through the determination processing of the first determination unit 114 for all selected combinations of the bit accuracy and the number of units, to the output unit 118 as a final determination.

The output unit 118 outputs the finally determined combination of the bit accuracy and the number of units. Specifically, the output unit 118 outputs the bit accuracy and the number of units finally determined to the inference calculation unit 13.

Next, the configurations of the memory control unit 11, the storage unit 12, and the inference calculation unit 13 included in the inference processing apparatus 1 will be described.

The memory control unit 11 reads input data X, weight data W of a neural network, and output data hₜ₋₁ from the storage unit 12 and transfers them to the inference calculation unit 13. More specifically, the memory control unit 11 reads weight data W of a neural network having the number of units set by the setting unit 10 from the storage unit 12.

The storage unit 12 stores input data X such as time series data acquired from an external sensor or the like. The storage unit 12 also stores trained NNs that have been pre-trained and constructed through a calculation device such as an external server. The storage unit 12 stores trained NNs of different network sizes having at least the number of units selected by the selection unit 110. For example, trained NNs having 100, 200, and 300 units are preloaded into the storage unit 12.

The storage unit 12 may store, for example, weight data W, which is data of trained parameters of a DNN partially including an RNN, for each network size as a trained NN model. The storage unit 12 also stores a return value ht, from a hidden layer of the RNN obtained by the inference calculation unit 13.

The inference calculation unit 13 takes the input data X, the weight data W, and the output data ht, which is the return value as inputs and performs calculation of the neural network based on the bit accuracy and the number of units set by the setting unit 10 to infer features of the input data X, and outputs the inference result.

Specifically, the inference calculation unit 13 performs a matrix operation of the input data X, the weight data W, and the output data hₜ₋₁. More specifically, the inference calculation unit 13 performs a matrix operation of input data X of each cycle of the RNN and weight data W based on the NN model for the input data X and a matrix operation of an output result hₜ₋₁ of an immediately previous cycle and weight data W based on the NN model for the output result hₜ₋₁.

The inference calculation unit 13 applies an activation function such as a tan h function, a sigmoid function, a softmax function, or ReLU to the results of the matrix operation to determine how the sum of the results of the matrix operation is activated and outputs the determination as an inference result Y.

Hardware Configuration of Inference Processing Apparatus

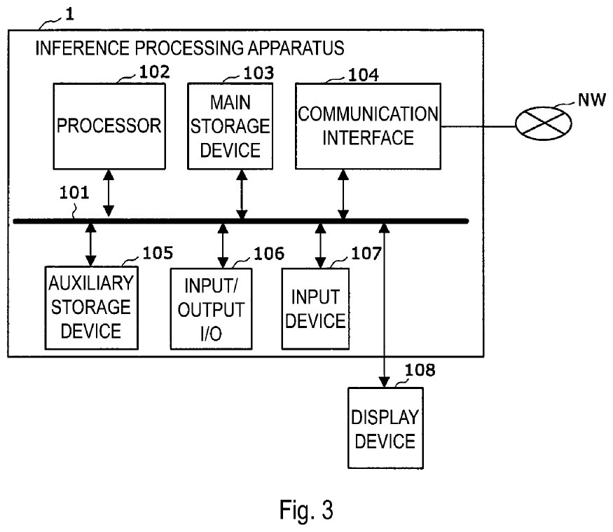

Next, an example of a hardware configuration of the inference processing apparatus 1 configured as described above will be described with reference to FIG. 3.

As illustrated in FIG. 3, the inference processing apparatus 1 can be implemented, for example, by a computer including a processor 102, a main storage device 103, a communication interface 104, an auxiliary storage device 105, an input/output I/O 106, and an input device 107 which are connected via a bus 101 and a program that controls these hardware resources. For example, a display device 108 may be connected to the inference processing apparatus 1 via the bus 101 to display the inference result or the like on a display screen. Also, a sensor (not illustrated) may be connected to the inference processing apparatus 1 via the bus 101 to measure input data X including time series data such as audio data to be inferred by the inference processing apparatus 1

The main storage device 103 is implemented, for example, by semiconductor memories such as an SRAM, a DRAM, and a ROM. The main storage device 103 implements the storage units 12 and 113 described above with reference to FIG. 1.

The main storage device 103 stores in advance programs for the processor 102 to perform various controls and calculations. Each function of the inference processing apparatus 1 including the setting unit 10, the memory control unit 11, and the inference calculation unit 13 illustrated in FIGS. 1 and 2 is implemented by the processor 102 and the main storage device 103.

The communication interface 104 is an interface circuit for communicating with various external electronic devices via a communication network NW. The inference processing apparatus 1 may receive weight data W of a trained neural network from the outside via the communication interface 104 or may send an inference result Y to the outside.

For example, an interface and an antenna compatible with a wireless data communication standard such as LTE, 3G, 5G, wireless LAN, or Bluetooth (registered trademark) are used as the communication interface 104. The communication network NW includes, for example, a wide area network (WAN), a local area network (LAN), the Internet, a dedicated line, a wireless base station, or a provider.

The auxiliary storage device 105 includes a readable and writable storage medium and a drive device for reading and writing various information such as programs, data, and the like from and to the storage medium. A semiconductor memory such as a hard disk or a flash memory can be used as a storage medium of the auxiliary storage device 105.

The auxiliary storage device 105 has a program storage area for storing a program for setting the bit accuracy of inference calculation and the number of units of the NN model to be used when the inference processing apparatus 1 performs inference processing and a program for performing the inference calculation. Further, the auxiliary storage device 105 may have, for example, a backup area for backing up the data, programs, and the like described above.

The input/output I/O 106 includes I/O terminals for inputting a signal from an external device such as the display device 108 or outputting a signal to the external device.

The input device 107 includes a keyboard, a touch panel, or the like and generates and outputs a signal corresponding to a key press or a touch operation. For example, the value of the required inference accuracy described with reference to FIGS. 1 and 2 is received by the user inputting an operation to the input device 107.

The inference processing apparatus 1 may not only be implemented by one computer but may also be distributed over a plurality of computers connected to each other through the communication network NW. Further, the processor 102 may also be implemented by hardware such as a field-programmable gate array (FPGA), large scale integration (LSI), or an application specific integrated circuit (ASIC).

Inference Processing Method

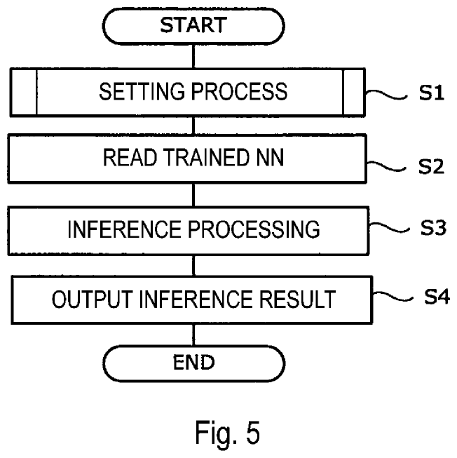

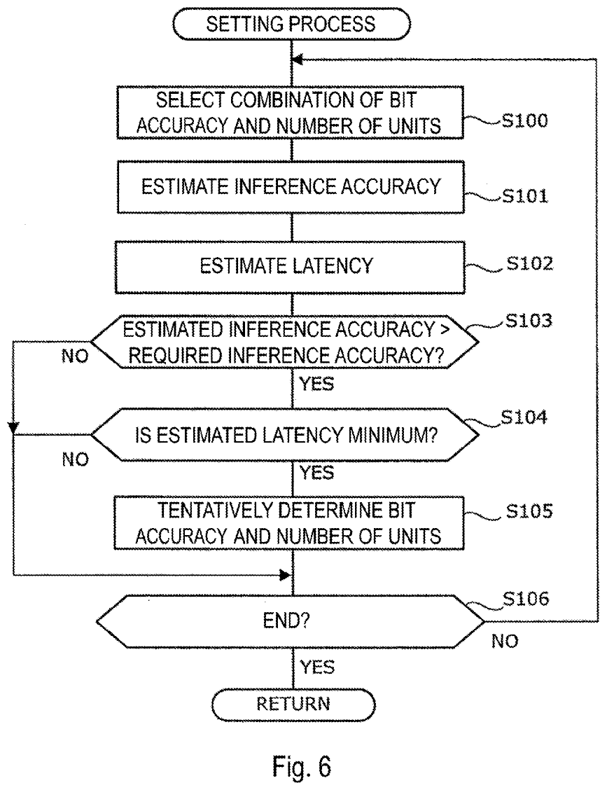

Next, the operation of the inference processing apparatus 1 configured as described above will be described with reference to flowcharts of FIGS. 5 and 6. In the following, it is assumed that trained NNs that have been pre-trained for different network sizes in a calculation device such as an external server have been loaded into the storage unit 12.

As illustrated in FIG. 5, first, the setting unit 10 sets the bit accuracy of inference calculation to be used by the inference calculation unit 13 and the number of units of the RNN layer based on a required inference accuracy input from the outside (step S1). Thereafter, the memory control unit 11 reads a trained NN model having the number of units set by the setting unit 10 from the storage unit 12 (step S2).

Next, the inference calculation unit 13 performs inference processing based on the bit accuracy of inference calculation set by the setting unit 10 (step S3). More specifically, the inference calculation unit 13 takes input data X, weight data W, and output data hₜ₋₁ as inputs and performs a matrix operation with the set bit accuracy. The inference calculation unit 13 applies an activation function to the sum of the results of the matrix operation to determine an output.

Thereafter, the inference calculation unit 13 outputs the result of inference calculation as an inference result Y (step S4).

Setting Process

Here, the setting process (step S1) illustrated in FIG. 5 will be described with reference to the flowchart of FIG. 6.

First, the selection unit 110 selects combinations of the bit accuracy of inference calculation and the number of units of the NN model based on a preset range of values of the bit accuracy of inference calculation and a preset range of values of the number of units of the RNN layer (step S100).

For example, as shown in FIG. 4, the selection unit 110 selects four values of bit accuracy (2 bits, 4 bits, 8 bits, and 16 bits) and selects three values (100, 200, and 300) as the number of units of the RNN layer. Further, the selection unit 110 selects combinations of the four different values of the bit accuracy and the three different numbers of units. The combinations of the bit accuracy and the number of units selected by the selection unit 110 are stored in the storage unit 113.

Next, the first estimation unit 111 estimates the inference accuracy of the inference result Y when the inference calculation unit 13 has performed the inference processing using each of the combinations of the bit accuracy and the number of units selected by the selection unit 110 (step S101). For example, the first estimation unit 111 estimates the value of the inference accuracy for each combination of the bit accuracy and the number of units as shown in FIG. 4. The first estimation unit 111 can estimate each inference accuracy at the time of circuit design of the inference calculation unit 13. The inference accuracy estimated by the first estimation unit 111 is stored in the storage unit 113.

Next, the second estimation unit 112 estimates the latencies of the entire inference processing when the inference calculation unit 13 has performed the inference processing by using the combinations of the bit accuracy and the number of units selected by the selection unit 110 (step S102). For example, the second estimation unit 112 estimates the latency value (in μs) for each combination of the bit accuracy and the number of units as shown in FIG. 4. The second estimation unit 112 can estimate each inference accuracy at the time of circuit design of the inference calculation unit 13. The latency estimated by the second estimation unit 112 is stored in the storage unit 113.

Next, when the first determination unit 114 has determined that the value of the inference accuracy estimated in step S101 is larger than the value of the required inference accuracy, that is, satisfies the required inference accuracy (step S103: YES), the second determination unit 115 performs determination processing for latency (step S104). More specifically, when the second determination unit 115 has determined that the latency value estimated in step S102 is the minimum among other latency values (step S104: YES), the determination unit 116 tentatively determines, as a set value, a combination of the bit accuracy and the number of units with which the minimum latency has been estimated (step S105).

Next, the end determination unit 117 performs an end determination, and when at least the determination processing of step S103 has been performed for all combinations of the bit accuracy and the number of units selected in step S100 (step S106: YES), outputs the combination of the bit accuracy and the number of units tentatively determined in step S105 as a final determination, and the process returns to step S2.

The inference processing apparatus 1 according to the first embodiment determines two parameters, the bit accuracy of inference calculation and the number of units of the NN model, based on a required inference accuracy as described above. This limits the latency of the entire inference processing to a smaller value while maintaining the inference accuracy of the inference result Y at the required accuracy, such that it is possible to reduce the processing time of inference calculation.

In particular, when the bit accuracy alone is adjusted as in the example of the related aft, the inference accuracy deteriorates if the bit accuracy is lowered. However, increasing the number of units based on a predetermined condition as in the present embodiment can limit the deterioration of the inference accuracy. On the other hand, when the number of units alone is adjusted, the latency of the entire inference processing becomes large as shown in FIG. 4. However, the inference processing apparatus 1 according to the present embodiment uses both the bit accuracy and the number of units as parameters and thus can limit an increase in the latency of inference processing.

The above embodiment has been described with reference to the case where the first determination unit 114 performs the inference accuracy determination (step S103 in FIG. 6) before the determination unit 116 tentatively determines a combination of the bit accuracy and the number of units (step S105 in FIG. 6). However, the first determination unit 114 may perform the inference accuracy determination after the determination unit 116 tentatively determines a combination of the bit accuracy and the number of units.

In this case, the inference accuracy obtained with the combination of the bit accuracy and the number of units tentatively determined by the determination unit 116 is calculated using a calculation device such as a separate external server and recorded in the storage unit 113. Then, the first determination unit 114 performs the determination processing using an inference accuracy corresponding to the tentatively determined combination stored in the storage unit 113 as a threshold value.

Similarly, the second determination unit 115 may perform the latency determination after the determination unit 116 performs the combination determination. In this case, when the combination has been tentatively determined by the determination unit 116, a latency obtained with the tentatively determined bit accuracy and number of units is recorded in the storage unit 113. The second determination unit 115 can perform the latency determination processing using the latency recorded in the storage unit 113 as a threshold value.

Another possible configuration is that in which the first estimation unit 111 and the second estimation unit 112 clarify in advance the relationships between a plurality of combinations of the value of bit accuracy and the number of units and the inference accuracy and the latency as shown in FIG. 4 and store the relationships in the storage unit 113, and then circuits of the inference calculation unit 13 are switched and used.

For example, a convolutional neural network (CNN), a long-term short-term memory (LSTM), a gated recurrent unit (GRU), a residual network (ResNet) CNN, other known neural network models having at least one intermediate layer, or a neural network combining these can be used in the inference processing apparatus 1 as a neural network model.

### Second Embodiment

Next, a second embodiment of the present invention will be described. In the following description, the same components as those in the first embodiment described above will be denoted by the same reference signs and description thereof will be omitted.

The first embodiment has been described with reference to the case where the setting unit 10 sets a bit accuracy of calculation in the inference calculation unit 13 and the number of units of the RNN layer based on a required inference accuracy of the inference result Y. On the other hand, in the second embodiment, the setting unit 10 monitors an inference accuracy acquired from the outside and sets a bit accuracy and the number of units according to the inference accuracy acquired from the outside. Hereinafter, components different from those of the first embodiment will be mainly described.

Configuration of Inference Processing Apparatus

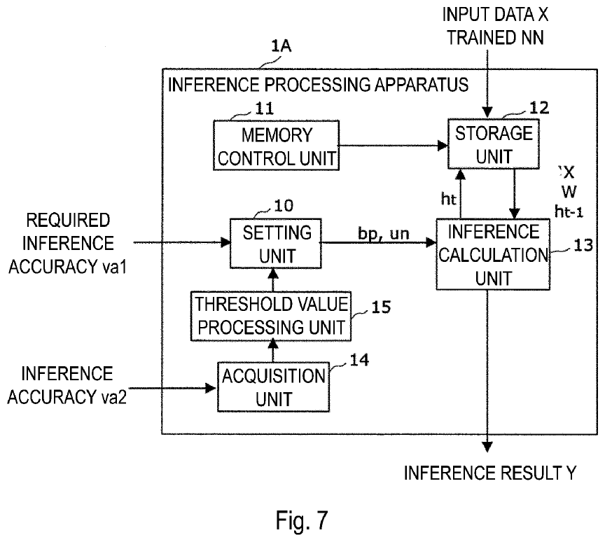

FIG. 7 is a block diagram illustrating a configuration of an inference processing apparatus 1A according to the present embodiment. The inference processing apparatus 1A differs from the first embodiment in that it further includes an acquisition unit 14 and a threshold value processing unit 15.

The acquisition unit 14 acquires an inference accuracy of the features of input data X inferred by the inference calculation unit 13. The acquisition unit 14 acquires, for example, an inference accuracy obtained through inference calculation performed with an initially set bit accuracy. The acquisition unit 14 can also acquire the inference accuracy from an external server or the like at regular intervals.

The inference accuracy acquired by the acquisition unit 14 is an inference accuracy obtained when, by using test data under the same conditions as the input data X, the inference processing apparatus 1A has performed inference calculation using a trained NN having a predetermined or initially set bit accuracy and a predetermined or initially set number of units. The inference accuracy is determined by comparing an inference result Y that the inference processing apparatus 1A outputs using the test data under the same conditions as the input data X with a correct inference result for the input data X.

Specifically, an external server or the like performs, for example, an inference calculation of a trained NN having an initially set number of units based on an initially set bit accuracy by using test data under the same conditions as the input data X used in the inference processing apparatus 1A. The acquisition unit 14 acquires the inference accuracy of the output inference result. The acquisition unit 14 may be configured to not only obtain the inference accuracy by analyzing test data under the same conditions as the input data X but also acquire an inference accuracy obtained as a result of analyzing the input data X.

The threshold value processing unit (a fifth determination unit) 15 performs threshold value processing on the inference accuracy acquired by the acquisition unit 14 using a preset threshold value for inference accuracy. For example, when the inference accuracy acquired by the acquisition unit 14 is lower than a threshold value equivalent to the required inference accuracy, the threshold value processing unit 15 outputs a signal instructing the setting unit 10 to set the number of bits and the number of units.

Based on the signal from the threshold value processing unit 15, the setting unit 10 sets a combination of the bit accuracy of inference calculation and the number of units of the RNN layer, the combination satisfying the required inference accuracy and minimizing the latency. For example, the setting unit 10 can set both or either of the bit accuracy and the number of units when the threshold value processing unit 15 has determined that the inference accuracy acquired by the acquisition unit 14 is lower than the threshold value.

The configuration of the setting unit 10 according to the present embodiment is similar to that of the first embodiment, and as illustrated in FIG. 2, the setting unit 10 includes a selection unit 110, a first estimation unit 111, a second estimation unit 112, a storage unit 113, a first determination unit 114, a second determination unit 115, a determination unit 116, an end determination unit 117, and an output unit 118.

Inference Processing Method

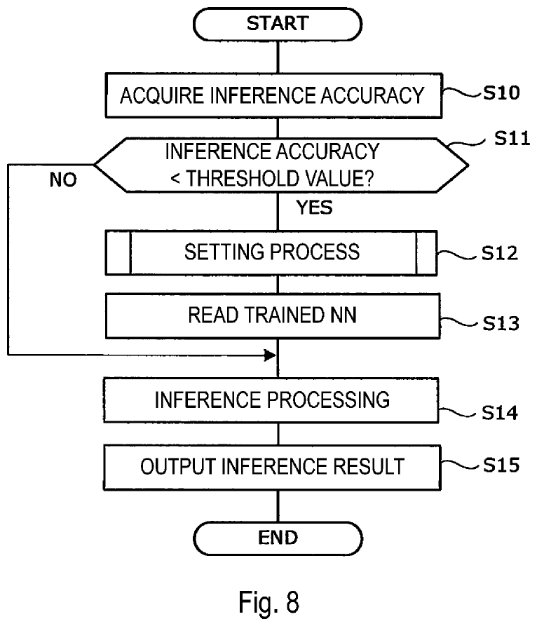

Next, the operation of the inference processing apparatus 1A configured as described above will be described with reference to a flowchart of FIG. 8. In the following, it is assumed that trained NNs that have been pre-trained for different network sizes in a calculation device such as an external server have been loaded into the storage unit 12. It is also assumed that arbitrary values such as initial values are used for the bit accuracy and the number of units of the RNN layer used in the calculation of the inference calculation unit 13 in the inference processing apparatus 1A.

As illustrated in FIG. 8, first, the acquisition unit 14 acquires an inference accuracy (step S10). More specifically, an external server or the like analyzes an inference accuracy obtained when the inference processing apparatus 1A has performed inference processing using test data under the same conditions as the input data X used in the inference processing apparatus 1A. The acquisition unit 14 can acquire the inference accuracy at regular intervals.

Next, the threshold value processing unit 15 performs threshold value processing. When the threshold value processing unit 15 has determined that the acquired inference accuracy value is lower than the set threshold value (step S11: YES), the setting unit 10 performs setting processing (step S12). As a set threshold value, the threshold value processing unit 15 can use, for example, a threshold value that is a value equivalent to an inference accuracy required for the inference result Y output by the inference processing apparatus 1A.

The setting unit 10 sets the bit accuracy of inference calculation and the number of units of the RNN layer by using an inference accuracy required by a system or service to which the inference processing apparatus 1A is applied (step S12). The setting process performed by the setting unit 10 is similar to the setting process that has been described with reference to FIG. 6. The setting unit 10 may be configured to not only set both the bit accuracy of inference calculation and the number of units of the RNN layer but also make a setting of changing either the bit accuracy or the number of units.

In this case, the inference accuracy of the features of the input data X that the inference calculation unit 13 infers when only one of the two parameters, the number of bits and the number of units, shown in FIG. 4 has changed is estimated (step S101 in FIG. 6). Similarly, the latency of the entire inference processing when the one of the parameters has changed is estimated (step S102 in FIG. 6).

For example, the inference accuracy and latency may be estimated with the number of units fixed and the bit accuracy alone changed to a higher value based on the inference accuracy acquired in step S10 and the determination (steps S103 and S104 in FIG. 6) may then be performed. Similarly, the inference accuracy and latency may be estimated with the bit accuracy fixed and the number of units of the RNN layer changed to a larger value based on the inference accuracy acquired in step S10 and the determination (steps S103 and S104 in FIG. 6) may then be performed.

When both the bit accuracy and the number of units are changed and set in the setting unit 10, the value of the required inference accuracy that the first determination unit 114 uses as a criterion for inference accuracy determination may be changed according to the value of the inference accuracy acquired in step S10. Similarly, the value of the latency that the second determination unit 115 uses as a criterion for latency determination may be changed according to the value of the inference accuracy acquired in step S10.

If the inference accuracy acquired in step S10 exceeds the threshold value in step S11 (step S11: NO), inference processing is performed without changing the bit accuracy of inference calculation and the number of units of the NN model currently used in the inference calculation unit 13 (step S14). The inference accuracy of the inference result Y output from the inference calculation unit 13 in this case satisfies the required inference accuracy and the latency of the inference processing becomes smaller.

Next, the memory control unit 11 reads a trained NN having the number of units set by the setting unit 10 from the storage unit 12 and transfers it to the inference calculation unit 13 (step S13). Thereafter, the inference calculation unit 13 takes input data X, weight data W, and output data hₜ₋₁ as inputs and performs an inference calculation of the trained NN based on the bit accuracy and the number of units of the RNN layer set by the setting unit 10 (step S14).

For example, consider the case where the setting unit 10 changes the values of the bit accuracy of inference calculation of the inference calculation unit 13 and the number of units of the RNN layer to different values. In this case, the memory control unit 11 can switch circuit configurations of the inference calculation unit 13 by switching the values based on a plurality of circuit configurations stored in the storage unit 12 in advance.

Further, a logic circuit corresponding to the bit accuracy set by the setting unit 10 can be dynamically reconfigured by using a device such as an FPGA whose logic circuit can be dynamically reconfigured.

Thereafter, the inference calculation unit 13 outputs an inference result Y for the input data X (step S15).

As described above, the inference processing apparatus 1A according to the second embodiment acquires an inference accuracy when the inference processing has been performed based on a predetermined bit accuracy of inference calculation and a predetermined number of units of the RNN layer by using test data under the same conditions as the input data X of the inference processing apparatus 1A. The inference processing apparatus 1A changes the bit accuracy and the number of units when the acquired inference accuracy is lower than an inference accuracy that has been set. By monitoring the inference accuracy in this way, the bit accuracy and the number of units can be set to improve the inference accuracy when the inference accuracy has been lowered.

The inference accuracy can be improved without changing the configuration of the inference processing apparatus 1A, for example, when the required inference accuracy has changed depending on the system to which the inference processing apparatus 1A according to the present embodiment is applied or depending on the service provided, when a method of operating the provided service has changed, or in response to changes in the external environment.

Further, when the monitored inference accuracy is obtained as a sufficiently high value, the inference processing apparatus 1A according to the present embodiment can limit the latency of the entire inference processing to a smaller value while maintaining the inference accuracy without changing the configuration of the inference processing apparatus 1A.

### Third Embodiment

Next, a third embodiment of the present invention will be described. In the following description, the same components as those in the first and second embodiments described above will be denoted by the same reference signs and description thereof will be omitted.

In the first and second embodiments, the setting unit 10 sets the bit accuracy and the number of units that satisfy the required inference accuracy and can limit the latency of the entire inference processing to a smaller value. On the other hand, in the third embodiment, a setting unit 10B sets the bit accuracy and the number of units taking into consideration a power consumption of the inference processing apparatus 1 associated with the execution of inference processing and the amount of hardware resources used in the inference calculation unit 13 in addition to the required inference accuracy. Hereinafter, components different from those of the first and second embodiments will be mainly described.

Configuration of Setting Unit

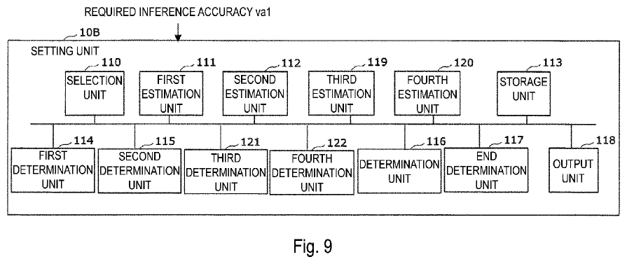

FIG. 9 is a block diagram illustrating a configuration of a setting unit 10B according to the present embodiment. The configuration of the inference processing apparatus 1 according to the present embodiment is similar to that of the first embodiment (see FIG. 1).

The setting unit 10B includes a selection unit no, a first estimation unit 111, a second estimation unit 112, a third estimation unit 119, a fourth estimation unit 120, a storage unit 113, a first determination unit 114, a second determination unit 115, a third determination unit 121, a fourth determination unit 122, a determination unit 116, an end determination unit 117, and an output unit 118.

The third estimation unit 119 estimates the amount of hardware resources used for the inference calculation of the inference calculation unit 13 corresponding to each combination of the bit accuracy and the number of units selected by the selection unit 110. “Hardware resources” refers to a memory capacity required to store input data X and weight data W, a combination circuit of standard cells required to construct a circuit for performing calculation processing such as addition and multiplication, or the like. For example, examples of hardware resources when an FPGA is used include a combinational circuit of flip-flops (FFs), look-up tables (LUTs), and digital signal processors (DSPs).

The third estimation unit 119 estimates the memory capacity of the entire inference processing apparatus 1 and the device scale of the entire inference processing apparatus 1, that is, the amount of hardware resources that the entire inference processing apparatus 1 has as a calculation circuit, for example, the numbers of FFs, LUTs, and DSPs when an FPGA is used. The amount of hardware resources used in the inference processing apparatus 1 estimated by the third estimation unit 119 is stored in the storage unit 113 in association with the combination of the bit accuracy and the number of units.

The fourth estimation unit 120 estimates a power consumption of the inference processing apparatus 1. More specifically, the fourth estimation unit 120 estimates a power consumption required for inference calculation performed by the inference calculation unit 13 based on each combination of the bit accuracy and the number of units selected by the selection unit 110. For example, the fourth estimation unit 120 obtains power consumed under a predetermined clock frequency or other conditions when the circuit of the inference calculation unit 13 is constructed based on the bit accuracy of inference calculation and the number of units.

For example, for each candidate combination of the bit accuracy and the number of units selected by the selection unit 110, the fourth estimation unit 120 estimates the amount of calculation for the number of units in units of multipliers and adders of the bit accuracy and estimates a power consumption associated with the processing of inference calculation. The power consumption of the inference processing apparatus 1 estimated by the fourth estimation unit 120 is stored in the storage unit 113 in association with the combination of the bit accuracy and the number of units.

The third determination unit 121 determines whether or not the amount of hardware resources used for the inference calculation estimated by the third estimation unit 119 satisfies a criterion preset for the amount of hardware resources. More specifically, the third determination unit 121 can make a determination using a threshold value set for the amount of hardware resources used stored in the storage unit 113. For example, an upper limit of the amount of hardware resources used can be used as a threshold value.

The fourth determination unit 122 determines whether or not the power consumption of the inference processing apparatus 1 estimated by the fourth estimation unit 120 satisfies a criterion preset for the power consumption. More specifically, the fourth determination unit 122 can make a determination using a threshold value set for the power consumption stored in the storage unit 113. For example, an upper limit of the power consumption can be used as a threshold value.

Setting Process

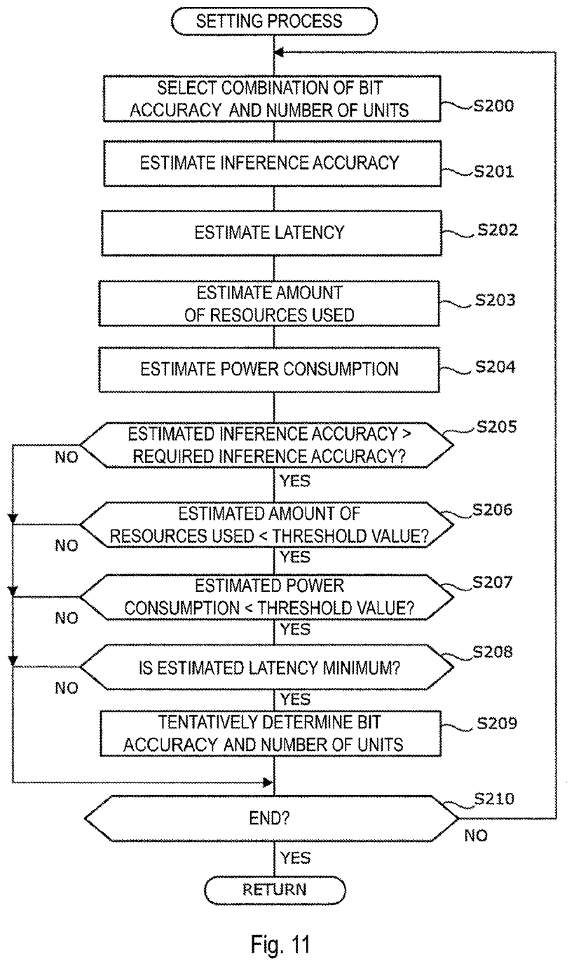

Next, a setting process performed by the setting unit 10B configured as described above will be described with reference to a flowchart of FIG. 11. In the following, it is assumed that the storage unit 113 stores the threshold values used by the third and fourth determination units 121 and 122 in advance.

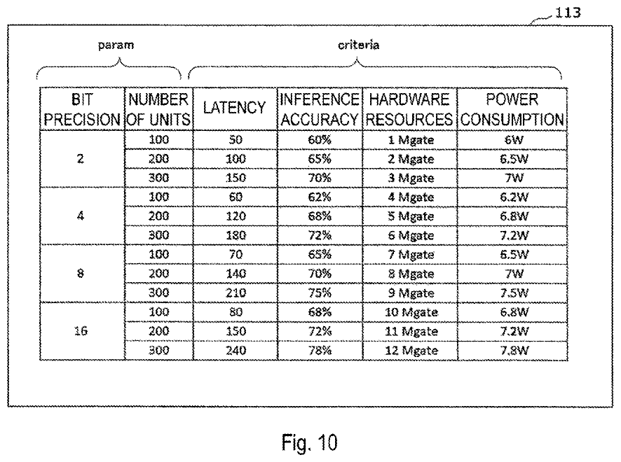

First, the selection unit 110 selects combinations of the bit accuracy and the number of units of the RNN layer based on a preset range of values of the bit accuracy and a preset range of values of the number of units of the RNN layer (step S200). The combinations of the bit accuracy and the number of units selected by the selection unit 110 are stored in the storage unit 113 as illustrated in FIG. 10.

Next, the first estimation unit 111 estimates the inference accuracy of the inference result Y when the inference calculation unit 13 has performed the inference processing using each of the combinations of the bit accuracy and the number of units selected by the selection unit 110 (step S201). For example, the first estimation unit 111 estimates the value of the inference accuracy for each combination of the bit accuracy and the number of units as shown in FIG. 10. The first estimation unit 111 can estimate each inference accuracy at the time of circuit design of the inference calculation unit 13. The inference accuracy estimated by the first estimation unit 111 is stored in the storage unit 113 as illustrated in FIG. 10.

Next, the second estimation unit 112 estimates the latencies of the entire inference processing when the inference calculation unit 13 has performed the inference processing by using the combinations of the bit accuracy and the number of units selected by the selection unit 110 (step S202). For example, the second estimation unit 112 estimates the latency value (for example, in μs) for each combination of the bit accuracy and the number of units as shown in FIG. 10. The second estimation unit 112 can estimate each inference accuracy at the time of circuit design of the inference calculation unit 13. The latency estimated by the second estimation unit 112 is stored in the storage unit 113 for each combination of the bit accuracy and the number of units as illustrated in FIG. 10.

Next, the third estimation unit 119 estimates the amount of hardware resources used in the inference processing apparatus 1 by using the combinations of the bit accuracy and the number of units selected by the selection unit 110 (step S203). The amount of hardware resources estimated by the third estimation unit 119 is stored in the storage unit 113 for each combination of the bit accuracy and the number of units as illustrated in FIG. 10.

Next, the fourth estimation unit 120 estimates the power consumption of the inference processing apparatus 1 by using the combinations of the bit accuracy and the number of units selected by the selection unit 110 (step S204). The amount of hardware resources estimated by the fourth estimation unit 120 is stored in the storage unit 113 for each combination of the bit accuracy and the number of units as illustrated in FIG. 10.

Next, when the first determination unit 114 has determined that the value of the inference accuracy estimated in step S201 satisfies the required inference accuracy (step S205: YES), the third determination unit 121 performs determination processing for the amount of hardware resources (step S206).

More specifically, when the third determination unit 121 has determined, using a threshold value set for the amount of hardware resources stored in the storage unit 113, that the estimated amount of hardware resources is lower than the threshold value (step S206: YES), the process proceeds to step S207.

More specifically, when the fourth determination unit 122 has determined that the power consumption of the inference processing apparatus 1 estimated in step S204 is lower than a threshold value for the power consumption stored in the storage unit 113 (step S207: YES), the process proceeds to step S208.

When the second determination unit 115 has determined that the latency value estimated in step S202 is the minimum among other latency values in step S208 (step S208: YES), the determination unit 116 tentatively determines, as a set value, a combination of the bit accuracy and the number of units with which the minimum latency has been estimated (step S209).

Next, the end determination unit 117 performs an end determination, and when at least the determination processing of step S205 has been performed for all combinations of the bit accuracy and the number of units selected in step S200 (step S210: YES), provides the combination of the bit accuracy and the number of units tentatively determined in step S209 as a final determination, and the process returns to step S2 in FIG. 5.

According to the third embodiment, the setting unit 10B adopts the value of bit accuracy and the number of units of a combination minimizing the latency of the entire inference processing among combinations that satisfy the required inference accuracy and use smaller amounts of hardware resources and lower power consumptions from among the combinations of the bit accuracy of inference calculation and the number of units of the RNN layer as described above.

Thus, it is possible to realize the inference processing apparatus 1 which satisfies the required inference accuracy, further limits the latency of the entire inference processing, has a smaller circuit scale, and has low power consumption.

In particular, when the amount of available hardware resources such as an FPGA is limited, it is also possible to limit the deterioration of inference accuracy and the increase in latency.

Further, when the inference processing apparatus 1 is applied to a system such as a sensor terminal that requires low power consumption, it is also possible to satisfy the required power consumption conditions and limit the deterioration of inference accuracy and the increase in latency.

The above embodiment has been described with reference to the case where the latency of the entire inference processing estimated by the second estimation unit 112 is compared with latency values obtained for other combinations of the bit accuracy and the number of units. However, the second determination unit 115 may determine whether or not the latency is the minimum using a preset threshold value as a criterion for latency determination.

### Fourth Embodiment

Next, a fourth embodiment of the present invention will be described. In the following description, the same components as those in the first to third embodiments described above will be denoted by the same reference signs and description thereof will be omitted.

In the first to third embodiments, the selection unit 110 selects combinations of the bit accuracy of inference calculation and the number of units of the RNN layer and the setting unit 10 sets combinations that satisfy the required inference accuracy and minimize the latency of inference processing from among the selected combinations. On the other hand, in the fourth embodiment, settings are made not only for the bit accuracy of inference calculation but also for the bit accuracy of input data X and the bit accuracy of weight data W.

The configuration of an inference processing apparatus 1 according to the present embodiment is similar to that of the first embodiment (FIG. 1).

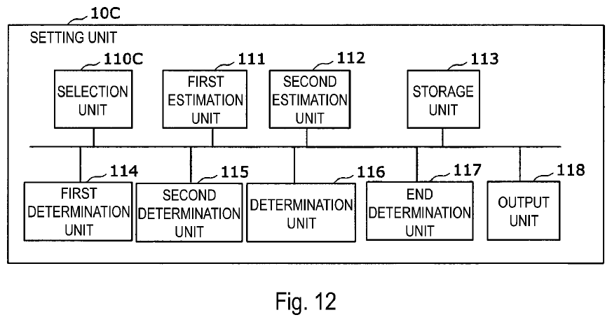

FIG. 12 is a block diagram illustrating the configuration of a setting unit 10C according to the present embodiment.

The setting unit 10C includes a selection unit 110C, a first estimation unit 111, a second estimation unit 112, a storage unit 113, a first determination unit 114, a second determination unit 115, a determination unit 116, an end determination unit 117, and an output unit 118.

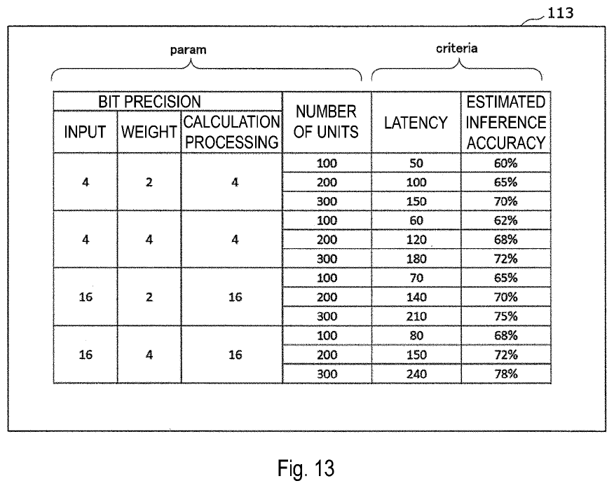

The selection unit 110C selects combinations of the bit accuracy of the input data X, the bit accuracy of the weight data, the bit accuracy of inference calculation, and the number of units of the NN model. For example, the selection unit 110C selects two values of bit accuracy, “4 bits” and “16 bits,” from a preset range of bit accuracy of the input data X as illustrated in FIG. 13.

The selection unit 110C also selects two values of bit accuracy, “2 bits” and “4 bits,” from a preset range of bit accuracy of the weight data W. Further, the selection unit 110C selects two values of bit accuracy, “4 bits” and “16 bits,” from a preset range of bit accuracy of inference calculation.

The selection unit 110C selects three values of the number of units, “100,” “200,” and “300,” from a preset range of the number of units which is the size of the neural network. Thus, in the example illustrated in FIG. 13, the selection unit 110C selects a total of 12 candidate combinations of the bit accuracy of the input data X, the bit accuracy of the weight data, the bit accuracy of inference calculation, and the number of units.

The selection unit 110C may apply an arbitrary algorithm when generating candidate combinations. When selecting the bit accuracy of inference calculation, the selection unit 110C can also select the higher of the selected values of the bit accuracy of the input data X and the selected values of the bit accuracy of the weight data W as values of the bit accuracy of inference calculation. The selection unit 110C can also arbitrarily select a more detailed data type for the bit accuracy such as a fixed point and a floating point.

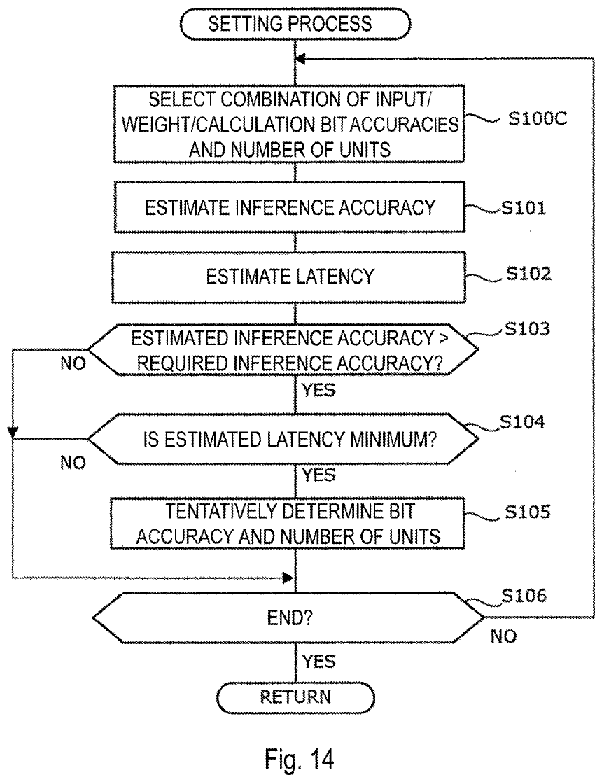

Next, a setting process performed by the setting unit 10C configured as described above will be described with reference to a flowchart of FIG. 14. The operation of the inference processing apparatus 1 is similar to the process (of steps S1 to S4) that has been described with reference to FIG. 5.

First, the selection unit 110C selects combinations of the bit accuracy of the input data X, the bit accuracy of the weight data W, the bit accuracy of inference calculation, and the number of units of the RNN layer based on preset ranges of values of the bit accuracies of the input data X, the weight data W, and the inference calculation and a preset range of values of the number of units of the RNN layer (step S100C). The combinations of the bit accuracies of the input data X, the weight data W, and the inference calculation and the number of units selected by the selection unit 110C are stored in the storage unit 113 as illustrated in FIG. 13.

Next, the first estimation unit 111 estimates inference accuracies obtained when the inference calculation unit 13 has performed the inference processing using combinations of the bit accuracy of the input data X, the bit accuracy of the weight data W, the bit accuracy of inference calculation, and the number of units selected by the selection unit 110C (step S101).

For example, the first estimation unit 111 estimates the value of the inference accuracy for each combination of the bit accuracy of the input data X, the bit accuracy of the weight data W, the bit accuracy of inference calculation, and the number of units as shown in FIG. 13. The first estimation unit 111 can estimate each inference accuracy at the time of circuit design of the inference calculation unit 13. The inference accuracy estimated by the first estimation unit 111 is stored in the storage unit 113 in association with each combination of the bit accuracies and the number of units as shown in FIG. 13.

Next, the second estimation unit 112 estimates the latencies of the entire inference processing when the inference calculation unit 13 has performed the inference processing by using the combinations of the bit accuracy of the input data X, the bit accuracy of the weight data W, the bit accuracy of inference calculation, and the number of units selected by the selection unit 110C (step S102).

For example, the second estimation unit 112 estimates the latency value (for example, in μs) for each combination of the bit accuracy of the input data X, the bit accuracy of the weight data W, the bit accuracy of inference calculation, and the number of units as shown in FIG. 14. The second estimation unit 112 can estimate each inference accuracy at the time of circuit design of the inference calculation unit 13. The latency estimated by the second estimation unit 112 is stored in the storage unit 113 in association with each combination of the bit accuracies and the number of units as shown in FIG. 14.

Next, when the first determination unit 114 has determined that the value of the inference accuracy estimated in step S101 exceeds the value of the required inference accuracy and satisfies the required inference accuracy (step S103: YES), the second determination unit 115 performs determination processing for latency (step S104). When the second determination unit 115 has determined that the latency value estimated in step S102 is the minimum of the latency values of the combinations of the bit accuracies and the number of units (step S104: YES), the determination unit 116 tentatively determines, as a set value, a combination of the bit accuracy of the input data X, the bit accuracy of the weight data W, the bit accuracy of inference calculation, and the number of units with which the minimum latency has been estimated (step S105).

Next, the end determination unit 117 performs an end determination, and when at least the determination processing of step S103 has been performed for all combinations of the bit accuracy of the input data X, the bit accuracy of the weight data W, the bit accuracy of inference calculation, and the number of units selected in step S100C (step S106: YES), determines the combination of the bit accuracy of the input data X, the bit accuracy of the weight data W, the bit accuracy of inference calculation, and the number of units tentatively determined in step S105 as a final set value, and the process returns to step S2 in FIG. 4.

In step S100C, the selection unit 110C may select candidate combinations in which, of the parameters regarding the three bit accuracies, the bit accuracy of the input data X, the bit accuracy of the weight data W, and the bit accuracy of inference calculation, parameters of a specific bit accuracy(s) are changeable.

For example, the selection unit 110C may select combinations in which the bit accuracy of the weight data W is fixed to “2 bits” and the other bit accuracies are each given a plurality of different values. Alternatively, the selection unit 110C may select combinations in which the value of only one of the three bit accuracies of the input data X, the weight data W, and the inference calculation is variable.

According to the fourth embodiment, it is possible to further improve the inference accuracy of the inference result Y from the inference calculation unit 13 and further limit the latency of the entire inference processing because a combination of the bit accuracy of the input data X, the bit accuracy of the weight data W, the bit accuracy of inference calculation, and the number of units, the combination satisfying the required inference accuracy and minimizing the latency of the entire inference processing, is set as described above.

Although embodiments of the inference processing apparatus and the inference processing method of embodiments of the present invention have been described above, the present invention is not limited to the described embodiments and various modifications conceivable by those skilled in the art can be made within the scope of the invention described in the claims.

For example, each functional unit other than the inference calculation unit in the inference processing apparatus of the present invention can be implemented by a computer and a program, and the program can be recorded on a recording medium or provided through a network.

### REFERENCE SIGNS LIST

1 Inference processing apparatus

10 Setting unit

11 Memory control unit

12, 113 Storage unit

13 Inference calculation unit

110 Selection unit

111 First estimation unit

112 Second estimation unit

114 First determination unit

115 Second determination unit

116 Determination unit

117 End determination unit

118 Output unit

101 Bus

102 Processor

103 Main storage device

104 Communication interface

105 Auxiliary storage device

106 Input/output I/O

107 Input device

108 Display device.

1-8. (canceled)

9. An inference processing apparatus configured to infer a feature of input data using a trained neural network, the inference processing apparatus comprising:
a first non-transitory storage medium configured to store the input data;
a second non-transitory storage medium configured to store a weight of the trained neural network;
a setting device configured to set a bit accuracy of inference calculation and set a number of units of the trained neural network based on an input inference accuracy; and
an inference calculator configured to:
perform an inference calculation of the trained neural network, taking the input data and the weight as inputs, based on the bit accuracy of the inference calculation and the number of units set by the setting device; and
infer the feature of the input data.

10. The inference processing apparatus according to claim 9, wherein the setting device includes:
a selection device configured to select a plurality of combinations, each of the plurality of combinations corresponding to a potential bit accuracy of the inference calculation and a potential number of units;
a first estimation device configured to estimate an inference accuracy of the feature of the input data inferred by the inference calculator based on each of the plurality of selected combinations;
a second estimation device configured to estimate a latency, the latency being a delay time of inference processing including the inference calculation performed by the inference calculator based on each of the plurality of selected combinations;
a first determination device configured to determine whether or not the inference accuracy estimated by the first estimation device satisfies the input inference accuracy; and
a second determination device configured to determine whether or not the latency estimated by the second estimation device is a minimum among latencies estimated for the plurality of combinations, wherein the bit accuracy of inference calculation and the number of units correspond to a selected combination of the plurality of combinations having an estimated latency that is the minimum among the latencies estimated for the plurality of combinations.

11. The inference processing apparatus according to claim 10, wherein the setting unit further includes:
a third estimation device configured to estimate an amount of hardware resources used for inference calculation of the inference calculator corresponding to the selected combination of the plurality of combinations; and
a third determination device configured to determine whether or not the amount of hardware resources estimated by the third estimation device satisfies a criterion set for the amount of hardware resources, wherein the third determination device has determined that the criterion set for the amount of hardware resources of the selected combination is satisfied.

12. The inference processing apparatus according to claim 10, wherein the setting device further includes:
a fourth estimation device configured to estimate a power consumption of the inference calculator based on each of a plurality of selected combinations, wherein the plurality of selected combinations comprises the selected combination; and
a fourth determination device configured to determine whether or not the power consumption estimated by the fourth estimation device satisfies a criterion set for the power consumption, wherein the fourth determination device has determined that the criterion set for an amount of hardware resources of the selected combination is satisfied.

13. The inference processing apparatus according to claim 10, wherein the selection device is configured to select a plurality of combinations of a bit accuracy of the input data, a bit accuracy of weight data, the bit accuracy of the inference calculation, and the number of units.

14. The inference processing apparatus according to claim 9, further comprising:
an acquisition device configured to acquire an inference accuracy of the feature of the input data inferred by the inference calculator; and
a fifth determination device configured to determine whether or not the inference accuracy is lower than a set inference accuracy,
wherein the setting device is configured to set the bit accuracy of the inference calculation or the number of units based on the input inference accuracy when the fifth determination device has determined that the inference accuracy acquired by the acquisition device is lower than the set inference accuracy.

15. An inference processing method for inferring a feature of input data using a trained neural network, the inference processing method comprising:
a first step of setting a bit accuracy of inference calculation and a number of units of the trained neural network based on an input inference accuracy; and
a second step of performing an inference calculation of the trained neural network, taking the input data stored in a first storage unit and a weight of the trained neural network stored in a second storage unit as inputs, based on the bit accuracy of the inference calculation and the number of units set in the first step to infer the feature of the input data.

16. The inference processing method according to claim 15, wherein the second step includes:
a third step of selecting a plurality of combinations, each of the plurality of combinations corresponding to a potential bit accuracy of the inference calculation and a potential number of units;
a fourth step of estimating an inference accuracy of the feature of the input data inferred in the second step based on each of the plurality of combinations;
a fifth step of estimating a latency which is a delay time of inference processing including the inference calculation performed in the second step based on each of the plurality of combinations;
a sixth step of determining whether or not the inference accuracy estimated in the fourth step satisfies the input inference accuracy; and
a seventh step of determining whether or not the latency estimated in the fourth step is a minimum among latencies estimated for the plurality of combinations,
wherein the bit accuracy of inference calculation and the number of units correspond to a selected combination of the plurality of combinations having an estimated latency that is the minimum among the latencies estimated for the plurality of combinations.
